(19) United States
(12) Patent Application Publication
(10) Pub. No.: US 2021/0142376 A1
(43) Pub. Date: May 13, 2021

(54) COMPATIBLE MODEL DETERMINATION FOR EFFICIENT LISTING CREATION

(71) Applicant: eBay Inc., San Jose, CA (US)

(72) Inventors: Ido Guy, Haifa (IL); Viatcheslav Novgorodov, Rishon leZion (IL)

(21) Appl. No.: 16/676,959

(22) Filed: Nov. 7, 2019

(51) Int. Cl. G06Q 30/06; G06N 5/04

(52) U.S. Cl. CPC G06Q 30/0601; G06N 20/00; G06N 5/04

(57) ABSTRACT

Systems and methods of improving the functioning of a computer system by implementing compatible model determination and recommendation for efficient item listing creation are disclosed. In some example embodiments, a computer system determines an identification of a target product, identifies online transactions for the target product involving purchasers of the target product based on the identification of the target product, identifies corresponding product models for the purchasers of the target product, selects at least one compatible model for the target product from the identified product models, and causes a recommendation for the at least one compatible model to be displayed on a computing device, with the recommendation recommending that the at least one compatible model for the target product be included in a title of an item listing for the target product.

### TECHNICAL FIELD

Embodiments of the present disclosure relate generally to the technical field of computer systems and, more particularly, but not by way of limitation, to systems and methods of improving the functioning of a computer system by determining and recommending accurate and relevant compatible models for inclusion in a title of an item listing during creation of the item listing.

### BACKGROUND

Current online services suffer from technical problems associated with the accuracy, relevancy, and efficiency of data included in item listings that are created and published via the online services. For many item listings, a key characteristic attribute is the list of brand models with which the items of the item listings are compatible (e.g., brand models to which the items fit). For potential buyers, the list of compatible models is an important feature when deciding if an item is relevant for them. For sellers, it is important to surface the list of compatible models in an efficient and effective way. One of the most visible features of an item listing is its title. For listings of the type described above, sellers may include the list of compatible models in the title to make it visible and easily findable by potential buyers. However, since the list of compatible items is often very long, sellers needs to choose a subset of the compatible models to include in the title. Current online services lack an efficient and effective way of enabling sellers to indicate compatible models in the titles of their item listings. User interface problems arise due to the fact that screen space is limited on many computing devices, especially on mobile devices, and the dedicated space provided for a title of an item listing is also limited, thereby making consequential the accuracy and relevancy with which the compatible models are determined for inclusion in the title.

The lack of accurate and relevant compatible brands in the titles of item listings can cause additional technical problems in the performance of the online services. For example, the accuracy and completeness of search results may be diminished based on titles of item listings not accurately reflecting the most relevant compatible brands for the items listings, as otherwise relevant item listings may be omitted from search results or presented in a way that does not accurately convey their relevance to end users. As a result, users often spend a longer time on their search, consuming electronic resources (e.g., network bandwidth, computational expense of server performing search). Users viewing user interfaces that lack certain types of data often waste time consuming electronic resources scrolling through the user interfaces in an unsuccessful attempt to find the missing data. Other technical problems can arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a networked system, in accordance with some example embodiments.

FIG. 2 illustrates components of a compatibility system, in accordance with some example embodiments.

FIG. 3 illustrates a graphical user interface (GUI) in which a search results page is displayed, in accordance with some example embodiments.

FIG. 4 illustrates a GUI in which an item listing page is displayed, in accordance with some example embodiments.

FIG. 5 illustrates a GUI in which an item listing creation page is displayed, in accordance with some example embodiments.

FIG. 6 illustrates a table of online transactions for products, in accordance with some example embodiments.

FIG. 7 illustrates a ranking of compatible models for a product based on corresponding numbers of transactions for the compatible models, in accordance with some example embodiments.

FIG. 8 illustrates a GUI in which a recommendation of compatible models to include in a title of an item listing is displayed on an item listing creation page, in accordance with some example embodiments.

FIG. 9 illustrates a GUI in which a recommendation of compatible models to include in a title of an item listing is displayed on an item listing creation page, in accordance with some example embodiments.

FIG. 10 is a flowchart illustrating a method of determining and recommending one or more compatible models to be included in a title of an item listing, in accordance with some example embodiments.

FIG. 11 is a flowchart illustrating another method of determining and recommending one or more compatible models to be included in a title of an item listing, in accordance with some example embodiments.

FIG. 12 is a flowchart illustrating yet another method of determining and recommending one or more compatible models to be included in a title of an item listing, in accordance with some example embodiments.

FIG. 13 is a block diagram illustrating a representative software architecture, in accordance with some example embodiments.

FIG. 14 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details, in general, well-known instruction instances, protocols, structures, and techniques have not been shown in detail.

The present disclosure provides technical solutions for improving the functioning of a computer system by determining accurate and relevant compatible models to be recommended for inclusion in a title of an item listing during creation of the item listing, as well as by enabling users to select the recommended compatible models for inclusion in the title via an enhanced user interface that conserves the electronic resources of the underlying computer system by making efficient use of screen space and reducing the navigation and other online operations that users perform in association with creating item listings.

The implementation of the features disclosed herein involves a non-generic, unconventional, and non-routine operation or combination of operations. By applying one or more of the solutions disclosed herein, some technical effects of the system and method of the present disclosure are to reduce network bandwidth consumption and network latency associated with inaccurate, irrelevant, and inefficient item listing creation. As a result, the functioning of the computer system is improved. Other improvements to the functioning of a computer or machine are also apparent from this disclosure.

In some example embodiments, operations are performed by a computer system or other machine having a memory and at least one hardware processor, with the operations comprising: determining an identification of a target product, identifying online transactions for the target product based on the identification of the target product, with the online transactions involving purchasers of the target product, identifying corresponding product models for the purchasers of the target product, selecting at least one compatible model for the target product from the identified product models, and causing a recommendation for the at least one compatible model to be displayed on a computing device, with the recommendation recommending that the at least one compatible model for the target product be included in a title of an item listing for the target product. In some example embodiments, the online transactions for the target product are identified based on the online transactions occurring during a most recent period of time. In some example embodiments, the recommendation is displayed within a listing creation user interface operable to receive user input for creating the item listing.

The methods or embodiments disclosed herein can be implemented as a computer system having one or more modules (e.g., hardware modules or software modules). Such modules can be executed by one or more hardware processors of the computer system. The methods or embodiments disclosed herein can be embodied as instructions stored on a machine-readable medium that, when executed by one or more processors, cause the one or more processors to perform the instructions.

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), a client application 114, and a programmatic client 116 executing on a client device 110.

The client device 110 may comprise, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 1.20 and a web server 122 are coupled to, and provide programmatic and web interfaces respectively to, one or more application servers 140. The application servers 140 may host one or more publication systems 142, payment systems 144, and a compatibility system 150, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The publication system 142 can be hosted on dedicated or shared server machines that are communicatively coupled to enable communications between server machines. The services themselves are communicatively coupled (e.g., via appropriate interfaces) to each other and to various data sources, so as to allow information to be passed between the services or so as to allow the services to share and access common data. Furthermore, the services can access one or more databases 126 via the database servers 124.

The publication system 142 can provide a number of publishing, listing, and/or price-setting mechanisms whereby a seller (also referred to as a first user) can list (or publish information concerning) goods or services for sale or barter, a buyer (also referred to as a second user) can express interest in or indicate a desire to purchase or barter such goods or services, and a transaction (such as a trade) can be completed pertaining to the goods or services. To this end, the publication system 142 can comprise at least one publication engine and one or more selling engines. The publication engine can publish information, such as item listings or product description pages, on the publication system 142. In some embodiments, the selling engines can comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines can also provide a number of features in support of these auction-format listings, such as a reserve price feature whereby a seller can specify a reserve price in connection with a listing and a proxy-bidding feature whereby a bidder can invoke automated proxy bidding. The selling engines can further comprise one or more deal engines that support merchant-generated offers for products and services.

The publication system 142 may also comprise a listing engine that allows sellers to conveniently author listings of items or authors to author publications. In one embodiment, the listings pertain to goods or services that a user (e.g., a seller) wishes to transact via the publication system 142. In some embodiments, the listings can be an offer, deal, coupon, or discount for the good or service. Each good or service is associated with a particular category. The listing engine can receive listing data such as title, description, and aspect name/value pairs. Furthermore, each listing for a good or service can be assigned an item identifier. In other embodiments, a user can create a listing that is an advertisement or other form of information publication. The listing information can then be stored to one or more storage devices coupled to the publication system 142 (e.g., databases 126) Listings also can comprise product pages that display a product and information (e.g., product title, specifications, descriptions, and reviews) associated with the product. In some embodiments, the product page can include an aggregation of item listings that correspond to the product described on the product page.

The listing engine can also allow buyers to conveniently author listings or requests for items desired to be purchased. In some embodiments, the listings can pertain to goods or services that a user (e.g., a buyer) wishes to transact via the publication system 142. Each good or service is associated with a particular category. The listing engine can receive as much or as little listing data, such as title, description, and aspect name/value pairs, that the buyer is aware of about the requested item. In some embodiments, the listing engine can parse the buyer's submitted item information and can complete incomplete portions of the listing. For example, if the buyer provides a brief description of a requested item, the listing engine can parse the description, extract key terms, and use those terms to make a determination of the identity of the item. Using the determined item identity, the listing engine can retrieve additional item details for inclusion in the buyer item request. In some embodiments, the listing engine can assign an item identifier to each listing for a good or service.

In some embodiments, the listing engine allows sellers to generate offers for discounts on products or services. The listing engine can receive listing data, such as the product or service being offered, a price and/or discount for the product or service, a time period for which the offer is valid, and so forth. In some embodiments, the listing engine permits sellers to generate offers from the sellers' mobile devices. The generated offers can be uploaded to the publication system 142 for storage and tracking.

Searching the publication system 142 may be facilitated by a searching engine. For example, the searching engine enables keyword queries of listings published via the publication system 142. In example embodiments, the searching engine receives the keyword queries from a device of a user and conducts a review of the storage device storing the listing information. The review will enable compilation of a result set of listings that can be sorted and returned to the client device 110 of the user. The searching engine can record the query (e.g., keywords) and any subsequent user actions and behaviors (e.g., navigations).

The searching engine also can perform a search based on the location of the user. A user can access the searching engine via a mobile device and generate a search query. Using the search query and the user's location, the searching engine can return relevant search results for products, services, offers, auctions, and so forth to the user. The searching engine can identify relevant search results both in a list form and graphically on a map. Selection of a graphical indicator on the map can provide additional details regarding the selected search result. In some embodiments, the user can specify as part of the search query a radius or distance from the user's current location to limit search results.

The searching engine also can perform a search based on an image. The image can be taken from a camera or imaging component of a client device or can he accessed from storage.

In a further example, the publication system 142 comprises a navigation engine that allows users to navigate through various categories, catalogs, or inventory data structures according to which listings can be classified within the publication system 142. For example, the navigation engine may allow a user to successively navigate down a category tree comprising a hierarchy of categories (e.g,, the category tree structure) until a particular set of listings is reached, Various other navigation applications within the navigation engine can be provided to supplement the searching and browsing applications. The navigation engine can record the various user actions (e.g., clicks) performed by the user in order to navigate down the category tree.

Since implementation of the publication system 142 may involve communication of data between the services of the publication system, in some example embodiments, the compatibility system 150 is implemented in the publication system 142 to make such communication more effective and efficient.

The compatibility system 150 provides functionality operable to perform various data generation and user interface operations, as will be discussed in further detail below. The compatibility system 150 may access the data from the databases 126, the third party servers 130, the publication system 142, and other sources. In some example embodiments, the compatibility system 150 may analyze the data to perform data generation and user interface operations. In some example embodiments, the compatibility system 150 communicates with the publication systems 142 (e.g., accessing item listings) and payment system 144. In an alternative embodiment, the compatibility system 150 is a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and compatibility system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

In some example embodiments, various tables are maintained within the database(s) 126 and are utilized by and support the systems 142, 144, and 150. A user table may contain a record for each registered user of the networked system 102, and can include identifier, address and financial instrument information pertaining to each such registered user. A user can operate as a seller, a buyer, or both, within the networked system 102. In one example embodiment, a buyer can be a user that has accumulated value (e.g., commercial or proprietary currency), and is accordingly able to exchange the accumulated value for items that are offered for sale by the networked system 102.

The tables may also include an items table in which are maintained item records for goods and services that are available to be, or have been, transacted via the networked system 102. Each item record within the items table can furthermore be linked to one or more user records within the user table, so as to associate a seller and one or more actual or potential buyers with each item record.

The tables may also comprise a transaction table that contains a record for each transaction (e.g., a purchase or sale transaction) pertaining to items for which records exist within the items table, as well as an order table that is populated with order records, with each order record being associated with an order. Each order, in turn, can be associated with one or more transactions for which records exist within the transaction table.

Bid records within a bids table may each relate to a bid received at the networked system 102 in connection with an auction-format listing supported by an auction application. A feedback table may be utilized by one or more reputation applications, in one example embodiment, to construct and maintain reputation information concerning users. A history table can maintain a history of transactions to which a user has been a party. One or more attributes tables may record attribute information pertaining to items for which records exist within the items table. Considering only a single example of such an attribute, the attributes tables can indicate a currency attribute associated with a particular item, with the currency attribute identifying the currency of a price for the relevant item as specified by a seller.

In some example embodiments, the tables also include a products table in which are maintained product records for goods and services that are available to be, or have been, transacted via the networked system 102. Each product record within the products table can furthermore be linked to one or more user records within the user table, so as to associate a seller and one or more actual or potential buyers with each item record. In some example embodiments, a reviews table is utilized by one or more review applications, in one example embodiment, to construct and maintain reviews concerning products. Such product reviews can be authored and submitted by users and can include, but are not limited to, text-based information describing a user's experience with the corresponding product, as well as one or more user-submitted ratings of the product, such as one or more graphical user interface elements that represent a rating (e.g., a star-based ratings system).

FIG. 2 is a block diagram illustrating components of the compatibility system 150, in accordance with some example embodiments. The compatibility system 150 is configured to perform the operations and implement the features disclosed herein with respect to determining and recommending accurate and relevant compatible models for inclusion in a title of an item listing during creation of the item listing. In some example embodiments, the compatibility system 150 comprises any combination of one or more of an identification module 210, a selection module 220, a user interface module 230, a machine learning module 240, and one or more databases 250. The modules 210, 220, 230, 240, and the database(s) 250 are communicatively coupled to each other. In some example embodiments, the modules 210, 220, 230, 240 and the database(s) 250 reside on a single machine having a memory and at least one hardware processor. In some example embodiments, one or more of the modules 210, 220, 230, 240, and the database(s) 250 reside on different machines. Database(s) 250, or a portion thereof, can be incorporated into the database(s) 126 of FIG. 1. The functionality of the modules 210, 220, 230, and 240 will be discussed in further detail below.

In some example embodiments, the compatibility system 150 is configured to determine and recommend accurate and relevant compatible models for inclusion in a title of an item listing during creation of the item listing. The titles of item listings may be displayed as part of search results in a search results page to represent those item listings in the displayed search results. FIG. 3 illustrates a GUI 300 in which a search results page is displayed, in accordance with some example embodiments. In the example shown in FIG. 3, the GUI 300 includes a search field 310 comprising text entered by a user as part of a search for item listings. The search field 310 comprises the text “BRAKE PADS TOYOTA” indicating that the user is searching for brake pads that are compatible with a Toyota vehicle. As a result of the user having entered this text into the search field 310 and having requested that a search be performed on the entered text (e.g., by selecting a “Search” button or the like), the compatibility system 150 receives the request, and performs a search for item listings that are relevant to the search query, such as item listings that correspond to brake pads that are compatible for Toyota vehicles. Based on the search, the compatibility system 150 displays a plurality of search results 320. Each search result 320 comprises a corresponding title 322 of the item listing to which the search result 320 corresponds. Each search result 320 may also comprise a corresponding image 324 that visually represents the item or an attribute of the item listing. Additional item attribute data may also be displayed as part of each search result 320, including, but not limited to, a condition of the item and a list price for the item.

The user may navigate to a corresponding item listing page for any one of the search results 320 by selecting (e.g., clicking on or tapping) the search result 320. FIG, 4 illustrates a GUI 400 in which an item listing page is displayed, in accordance with some example embodiments. In the example shown in FIG. 4, the user has selected the search result 320 in FIG. 3 that corresponds to “SET OF ACME BRAKE PADS, DISC BRAKE 1875832 NISSAN TOYOTA LEXUS VW,” resulting in the corresponding item listing page being displayed in the GUI 400 in FIG. 4. The item listing page displayed in the GUI 400 shows the title 322 and image 324 for the selected item listing. The item listing page also includes a dedicated section 410 in which a description 415 of the item is displayed. The description 415 may comprise text that is included in the title 322, as well as additional text that does not fit into the title 322.

Additional information associated with the item listing may be displayed as well, including, but not limited to a condition of the item, a list price of the item, how many of the items are still available for purchase, how many of the items have been sold, and the associated shipping cost for the item. Additionally, one or more selectable user interface elements may be displayed as part of the item listing page in order to enable the user to perform one or more corresponding online actions with respect to the item listing, including, but not limited to selectable user interface elements for buying the item of the item listing (e.g., a selectable “BUY IT NOW” button), adding the item to an online shopping cart of the user (e.g., a selectable “ADD TO CART” button), and adding the item listing to a watchlist of the user (e.g., a selectable “ADD TO WATCHLIST” button).

In some example embodiments, the compatibility system 150 is configured to enable a user to configure and create an item listing, and consequentially a corresponding item listing page, using one or more item listing creation pages. FIG. 5 illustrates a GUI 500 in which an item listing creation page is displayed, in accordance with some example embodiments. The example item listing creation page displayed within the GUI 500 comprises user interface elements 510, 520, 530, and 550 configured to enable the user to configure aspects of an item listing. For example, the user interface element 510 may comprise a text field configured to receive user-entered text specifying a title for the item listing (e.g., the title 322 in FIGS. 3 and 4). One or more user interface elements 520 may be configured to enable the user to submit one or more images for the item listing (e.g., the image 324 in FIGS. 3 and 4). The user interface element 530 may comprise a text field configured to receive user-entered text comprising a description of the item of the item listing (e.g., the description 415 in FIG. 4). The user interface element 540 may comprise a text field configured to receive user-entered text specifying a price for the item listing. The GUI 500 may comprise a selectable user interface element 550 configured to publish the item listing based on the user configuration, a selectable interface element 552 configured to display a preview of what a published version of the item listing will look like when published, and a selectable user interface element 554 configured to save the user configuration of the user interface elements of the item listing creation page in GUI 500 for subsequent retrieval so that the user can continue configuring the item listing at a future time.

The compatibility system 150 is configured to assist the user in configuring the item listing by recommending one or more compatible models to include in the title 322 of the item listing. In some example embodiments, the identification module 210 is configured to determine an identification of a target product (e.g., the product to be offered for sale via the item listing). The identification of the target product may be determined based on at least one of a keyword and an image submitted as input via a listing creation user interface operable to receive user input for creating the item listing. For example, the identification module 210 may detect that the user has entered “ACME BRAKE PADS 1875832” in the user interface element 510 for the title 322, and, based on an analysis of that user-entered text, determine a product ID for the item listing. Additionally, or alternatively, the identification module 210 may detect that the user has submitted (e.g., uploaded) one or more images 324 via the user interface element(s) 520, and, based on an analysis of the submitted image(s), determine a product ID for the item listing.

In some example embodiments, the identification module 210 is configured to identify online transactions for the target product based on the identification of the target product. Each online transaction involves a corresponding purchaser of the target product for that online transaction. In some example embodiments, the online transactions for the target product are identified based on the online transactions occurring during a most recent period of time. For example, the identification module 210 may identify all of the online transaction for the target product that occurred within the last nine months,

FIG. 6 illustrates a table 600 of online transactions for products, in accordance with some example embodiments. As seen in FIG. 6, the table comprises all of the transactions (e.g., TRANSACTION-1, TRANSACTION-2, . . . , TRANSACTION-N) for a target product (e.g., PRODUCT-1), as well the identification of the corresponding purchaser (e.g., PURCHASER-1, PURCHASER-2, . . . , PURCHASER-N) for each transaction. The information in the table 600 may be obtained by the identification module 210 via one or more of the tables previously discussed, such as the user table, the items table, and the transaction table.

In some example embodiments, the identification module 210 is configured to identify corresponding product models (e.g., MODEL-1, MODEL-2, MODEL-3, MODEL-4, . . . ) for the purchasers of the target product. The identification module 210 may determine the corresponding product models for purchasers by accessing profile information of the purchasers that explicitly identifies the corresponding product models. For example, each purchaser may have an online profile in which the purchaser has selected one or more product models to be associated with the purchaser, such as an automobile model corresponding to a vehicle that the purchaser owns, uses, or in which the purchaser is otherwise interested. Additionally or alternatively, the identification module 210 may determine the corresponding product model(s) for each purchaser by obtaining and analyzing a history of online purchases made by the purchaser to determine which models were identified as being compatible with the items included in the history of online purchases. For example, if a minimum threshold number of recent purchases of the purchaser involved items that were compatible with MODEL-1, then the identification module 210 may identify MODEL-1 as being a corresponding product model for the purchaser. It is contemplated that other ways of identifying the corresponding product models for the purchasers of target product are also within the scope of the present disclosure.

In some example embodiments, the selection module 220 is configured to select at least one compatible model for the target product from the identified product models. The selection of the compatible model(s) for the target product may be based on the number of online transactions for the target product that involved a purchaser associated with the compatible model(s), such as by using the information in the table 600. In some example embodiments, the selection module 220 ranks the identified product models based on a corresponding number of online transactions for each one of the identified product models, and then selects the compatible model(s) for target product based on the ranking.

FIG. 7 illustrates a ranking 700 of compatible models for a product based on corresponding numbers of transactions for the compatible models, in accordance with some example embodiments. The selection module 220 may select a top ranked portion of the identified product models (e.g., the top three ranked compatible models, the top five percent of ranked compatible models). For example, using the ranking 700 in FIG. 7, the selection module 220 may select MODEL-1, MODEL-4, and MODEL-2 based on those product models having the three highest number of online transactions. Alternatively, the selection module 220 may select all of the identified product models that have a corresponding number of online transactions that satisfy a minimum threshold number (e.g., select all product models having at least two-hundred corresponding online transactions). For example, the selection module 220 may select MODEL-1 and MODEL-4 based on those product models having corresponding numbers of online transactions that satisfy a minimum threshold number of two-hundred.

In some example embodiments, the user interface module 230 is configured to cause a recommendation for the at least one compatible model to be displayed on a computing device. The recommendation is configured to recommend that the selected compatible model(s) for the target product be included in a title of an item listing for the target product. The recommendation may be displayed within a listing creation user interface operable to receive user input for creating the item listing. FIG. 8 illustrates a GUI 800 in which a recommendation 810 of compatible models to include in a title of an item listing is displayed on an item listing creation page, in accordance with some example embodiments. The item listing creation page displayed within the GUI 800 of FIG. 8 may be similar to and have the same user interface elements as the item listing creation page displayed in the GUI 500 of FIG. 5. In FIG. 8, the recommendation 810 identifies the compatible models that are being recommended for inclusion in the title of the item listing and prompts the user to include the compatible models in the title of the item listing. The user can then enter one or more of the recommended compatible models for inclusion in the title of the item listing via the user interface element 510.

In some example embodiments, the recommendation for the at least one compatible model is displayed as an auto-completion suggestion for a user interface element of a listing creation user interface operable to receive user input for creating the item listing. The recommendation may be displayed based on one or more keywords submitted as input via the listing creation user interface. FIG. 9 illustrates a GUI 900 in which a recommendation 910 of compatible models to include in a title of an item listing is displayed on an item listing creation page, in accordance with some example embodiments. The item listing creation page displayed within the GUI 900 of FIG. 9 may be similar to and have the same user interface elements as the item listing creation page displayed in the GUI 500 of FIG. 5.

In the example shown in FIG. 9, the recommendation 910 is displayed as an auto-completion suggestion for the user interface element 510 of the listing creation user interface, which is operable to receive user input for creating the item listing. In the example shown in FIG. 9, the user interface module 230 detects the user-entered text “ACME BRAKE PADS 1875832” in the text field 510, and, in response to detecting the user-entered text, displays the recommendation 910 as an auto-completion suggestion in which the compatible models “NISSAN TOYOTA LEXUS” would be added to the user-entered text “ACME BRAKE PADS 1875832.” The user can then select to include one or more of the recommended compatible models for inclusion in the title of the item listing via the user interface element 510, such as by clicking or tapping on the recommendation 910. The user may also edit the title to remove one or more of the compatible models from the title after clicking or tapping on the recommendation 910. For example, the user may click on the recommendation 910, thereby causing the recommended compatible models to be included in the text field 510 for the title, and then delete one or more of the compatible models from the text field 510 in order to use an edited version of the recommendation 910 (e.g., a smaller portion of the recommended compatible models) for the title of the item listing.

In some example embodiments, the machine learning module 240 is configured to store records of the recommendations presented to users and the user responses to the recommendations of compatible models in the database(s) 250. For example, the machine learning module 240 may store a record of an instance in which a recommendation 810 or 910 is displayed to a user and also store a corresponding indication as to whether or not the user accepted or rejected the recommendation 810 or 910, such as which, if any, of the recommended compatible models did the user include in the title of the item listing. The machine learning module 240 may use these stored records of user responses as training data in one or more machine learning operations to train one or more models that are used by the identification module 210, the selection module 220, or the user interface module 230 in their respective operations. In this manner, the compatibility system 150 may improve the quality of its recommendations.

In some example embodiments, the selection module 220 stores the compatible model(s) that it selects in the database(s) 250 in association with the target product, and the user interface module 230 is configured to, when causing the recommendation for the compatible model(s) to be displayed on the computing device, detect that a user is creating the item listing for the target product via a listing creation user interface operable to receive user input for creating the item listing, and retrieve the compatible model(s) from the database 250 for inclusion in the recommendation 810 or 910 in response to, or otherwise based on, the detection of the user creating the item listing for the target product. For example, the user interface module 230 may detect that the user has entered text into the text field 510 for the title of the item listing, and then retrieve the compatible model(s) from the database 250 for inclusion in the recommendation 810 or 910 in response to the detection of the user-entered text into the text field 510.

In some example embodiments, the user interface module 230 receives keywords submitted by a user to be included in the title of the item listing for the target product via a listing creation user interface operable to receive user input for creating the item listing. The user interface module 230 may determine that the keywords submitted by the user comprise a total number of compatible models that exceeds a maximum threshold number of compatible models for the title of the item listing. For example, the user interface module 230 may determine that the user has entered five compatible models in the text field 510 for the title, which exceeds a maximum threshold number of three compatible models. In some example embodiments, the user interface module 230 is configured to display the recommendation for the compatible model(s) in response to, or otherwise based on, the determination the total number of compatible models submitted by the user in the title of the item listing exceeds the maximum threshold number of compatible models, thereby providing a dynamic user interface feature that reacts dynamically to user input to ensure that screen space is used efficiently.

In some example embodiments, the user interface module 230 determines which of the keywords submitted by the user are not included in the selected compatible model(s), and, based on the determination that keyword(s) are not included in the selected compatible model(s), displays suggestion to remove the keyword(s). For example, the user interface module 230 may determine that the user has entered five product models in the text field 510 for the title, but that two of the five product models entered by the user are not included in the compatible models selected by the selection module 220. Based on this determination, the user interface module 230 may display a recommendation to remove or omit those two product models from the title of the item listing.

FIG. 10 is a flowchart illustrating a method 1000 of determining and recommending one or more compatible models to be included in a title of an item listing, in accordance with some example embodiments. The operations of the method 1000 can be performed by a system or modules of a system. The operations of the method 1000 can be performed by processing logic that can comprise hardware (e.g., circuitry, dedicated logic, programmable logic, microcode, etc.), software (e.g., instructions run on a processing device), or a combination thereof. In one example embodiment, the method 1000 is performed by the compatibility system 150 of FIGS. 1 and 2, or any combination of one or more of its components or modules (e.g., identification module 210, selection module 220, user interface module 230), as described above.

At operation 1010, the compatibility system 150 determines an identification of a target product. In some example embodiments, the identification of the target product is determined based on at least one of a keyword and an image submitted as input via a listing creation user interface operable to receive user input for creating the item listing.

At operation 1020, the compatibility system 150 identifies online transactions for the target product based on the identification of the target product, the online transactions involving purchasers of the target product. In some example embodiments, the online transactions for the target product are identified based on the online transactions occurring during a most recent period of time.

At operation 1030, the compatibility system 150 identifies corresponding product models for the purchasers of the target product. The compatibility system 150 may determine the corresponding product models for the purchasers of the target product by accessing profile information of the purchasers that explicitly identifies the corresponding product models. For example, each purchaser may have an online profile in which the purchaser has selected one or more product models to be associated with the purchaser, such as an automobile model corresponding to a vehicle that the purchaser owns, uses, or in which the purchaser is otherwise interested. Additionally or alternatively, the compatibility system 150 may determine the corresponding product model(s) for each purchaser by obtaining and analyzing a history of online purchases made by the purchaser to determine which models were identified as being compatible with the items included in the history of online purchases. For example, if a minimum threshold number of recent purchases of the purchaser involved items that were compatible with MODEL-1, then the compatibility system 150 may identify MODEL-1 as being a corresponding product model for the purchaser. It is contemplated that other ways of identifying the corresponding product models for the purchasers of target product are also within the scope of the present disclosure.

At operation 1040, the compatibility system 150 selects at least one compatible model for the target product from the identified product models. In some example embodiments, the selecting the at least one compatible model for the target product from the identified product models comprises ranking the identified product models based on a corresponding number of online transactions for each one of the identified product models, and selecting the at least one compatible model for target product based on the ranking.

At operation 1050, the compatibility system 150 causes a recommendation for the at least one compatible model to be displayed on a computing device. In some example embodiments, the recommendation recommends that the at least one compatible model for the target product be included in a title of an item listing for the target product. The recommendation may be displayed within a listing creation user interface operable to receive user input for creating the item listing. In some example embodiments, the recommendation for the at least one compatible model is displayed as an auto-completion suggestion for a user interface element of a listing creation user interface operable to receive user input for creating the item listing. The recommendation may be displayed based on one or more keywords submitted as input via the listing creation user interface.

It is contemplated that the operations of the method 1000 can incorporate any of the other features disclosed herein.

FIG. 11 is a flowchart illustrating another method 1100 of determining and recommending one or more compatible models to be included in a title of an item listing, in accordance with some example embodiments. The operations of the method 1100 can be performed by a system or modules of a system. The operations of the method 1100 can be performed by processing logic that can comprise hardware (e.g., circuitry, dedicated logic, programmable logic, microcode, etc.), software (e.g., instructions run on a processing device), or a combination thereof. In one example embodiment, the method 1100 is performed by the compatibility system 150 of FIGS. 1 and 2, or any combination of one or more of its components or modules (e.g., identification module 210, selection module 220, user interface module 230), as described above.

The method 1100 comprises operations 1110 and 1120, which may be performed in conjunction with the operations of the method 1000. For example, operations 1110 and 1120 may be performed at any point prior to operation 1050 of the method 1000. At operation 1110, the compatibility system 150 receives keywords submitted by a user to be included in the title of the item listing for the target product via a listing creation user interface operable to receive user input for creating the item listing. At operation 1120, the compatibility system 150 determines that the keywords submitted by the user comprise a total number of compatible models that exceeds a maximum threshold number of compatible models for the title of the item listing. At operation 1050, as performed in the method 1100, the recommendation for the at least one compatible model is caused to be displayed on the computing device in response to, or otherwise based on, the determination at operation 1120 that the keywords submitted by the user comprise the total number of compatible models that exceeds the maximum threshold number of compatible models.

In some example embodiments, at operation 1120, the compatibility system 150 determines that one or more of the keywords are not included in the selected at least one compatible model, and, based on the determination that the one or more keywords are not included in the selected at least one compatible model, the recommendation comprises a suggestion to remove the one or more of the keywords.

It is contemplated that the operations of the method 1100 can incorporate any of the other features disclosed herein.

FIG. 12 is a flowchart illustrating yet another method of determining and recommending one or more compatible models to be included in a title of an item listing, in accordance with some example embodiments. The operations of the method 1200 can be performed by a system or modules of a system. The operations of the method 1200 can be performed by processing logic that can comprise hardware (e.g., circuitry, dedicated logic, programmable logic, microcode, etc.), software (e.g., instructions run on a processing device), or a combination thereof. In one example embodiment, the method 1200 is performed by the compatibility system 150 of FIGS. 1 and 2, or any combination of one or more of its components or modules (e.g., identification module 210, selection module 220, user interface module 230), as described above.

The method 1200 comprises operation 1245, which may be performed in conjunction with the operations of the method 1000. For example, operation 1245 may be performed subsequent to operation 1040 of the method 1000 and prior to operation 1050 of the method 1000.

At operation 1245, the compatibility system 150 stores the at least one compatible model that was selected at operation 1040 in a database in association with the target product. At operation 1050, as performed in the method 1200, the causing the recommendation for the at least one compatible model to be displayed on the computing device comprises detecting that a user is creating the item listing for the target product via a listing creation user interface operable to receive user input for creating the item listing, and retrieving the at least one compatible model from the database for inclusion in the recommendation based on the detecting that the user is creating the item listing for the target product.

It is contemplated that the operations of the method 1200 can incorporate any of the other features disclosed herein.

It is contemplated that any features of any embodiments disclosed herein can be combined with any other features of any other embodiments disclosed herein. Accordingly, any such hybrid embodiments are within the scope of the present disclosure.

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications and so forth described in conjunction with FIGS. 1-12 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the features of the present disclosure in different contexts from the disclosure contained herein.

FIG. 13 is a block diagram 1300 illustrating a representative software architecture 1302, which may be used in conjunction with or as part of the compatibility system 150. FIG. 13 is merely a non-limiting example of a software architecture 1302 and it will be appreciated that many other architectures may be implemented to facilitate the functionality described herein. The software architecture 1302 may be executing on hardware such as a machine that includes, among other things, processors, memory/storage, and I/O components. A representative hardware layer 1304 is illustrated in FIG. 13 and can represent, for example, the machine 1400 of FIG. 14. The representative hardware layer 1304 comprises one or more processing units 1306 having associated executable instructions 1308. The executable instructions 1308 represent the executable instructions of the software architecture 1302, including implementation of the methods, modules, and features disclosed above with respect to FIGS. 1-12. The hardware layer 1304 also includes memory and/or storage modules 1310, which also have the executable instructions 1308. The hardware layer 1304 may also comprise other hardware 1312, which represents any other hardware of the hardware layer 1304, such as the other hardware illustrated as part of the machine 1400.

In the example architecture of FIG. 13, the software architecture 1302. may be conceptualized as a stack of layers where each layer provides particular functionality. For example, the software architecture 1302 may include layers such as an operating system 1314, libraries 1316, frameworks/middleware 1318, applications 1320, and a presentation layer 1344. Operationally, the applications 1320 and/or other components within the layers may invoke application programming interface (API) calls 1324 through the software stack and receive a response, returned values, and so forth, illustrated as messages 1326, in response to the API calls 1324. The layers illustrated are representative in nature and not all software architectures have all layers. For example, some mobile or special purpose operating systems may not provide a frameworks/middleware 1318, while others may provide such a layer. Other software architectures may include additional or different layers.

The operating system 1314 may manage hardware resources and provide common services. The operating system 1314 may include, for example, a kernel 1328, services 1330, and drivers 1332. The kernel 1328 may act as an abstraction layer between the hardware and the other software layers. For example, the kernel 1328 may be responsible for memory management, processor management (e.g., scheduling), component management, networking, security settings, and so on. The services 1330 may provide other common services for the other software layers. The drivers 1332 may be responsible for controlling or interfacing with the underlying hardware. For instance, the drivers 1332 may include display drivers, camera drivers, Bluetooth° drivers, flash memory drivers, serial communication drivers (e.g., Universal Serial Bus (USB) drivers), Wi-Fi® drivers, audio drivers, power management drivers, and so forth depending on the hardware configuration.

The libraries 1316 may provide a common infrastructure that may be utilized by the applications 1320 or other components or layers. The libraries 1316 typically provide functionality that allows other software modules to perform tasks in an easier fashion than to interface directly with the underlying operating system 1314 functionality (e.g., kernel 1328, services 1330, and/or drivers 1332). The libraries 1316 may include system libraries 1334 (e.g., C standard library) that may provide functions such as memory allocation functions, string manipulation functions, mathematic functions, and the like. In addition, the libraries 1316 may include API libraries 1336 such as media libraries (e.g., libraries to support presentation and manipulation of various media formats such as MPEG4, H.264, MP3, AAC, AMR, TPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1316 may also include a wide variety of other libraries 1338 to provide many other APIs to the applications 1320 and other software components/modules.

The frameworks/middleware 1318 may provide a higher-level common infrastructure that may be utilized by the applications 1320 or other software components/modules. For example, the frameworks/middleware 1318 may provide various graphic user interface (GUI) functions, high-level resource management, high-level location services, and so forth. The frameworks/middleware 1318 may provide a broad spectrum of other APIs that may be utilized by the applications 1320 or other software components/modules, some of which may be specific to a particular operating system or platform.

The applications 1320 include built-in applications 1340 or third party applications 1342. Examples of representative built-in applications 1340 may include, but are not limited to, a contacts application, a browser application, a book reader application, a location application, a media application, a messaging application, or a game application. The third party applications 1342 may include any of the built in applications 1340 as well as a broad assortment of other applications. In a specific example, the third party application 1342 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1342 may invoke the API calls 1324 provided by the mobile operating system such as the operating system 1314 to facilitate functionality described herein.

The applications 1320 may utilize built-in operating system functions (e.g., kernel 1328, services 1330, and/or drivers 1332), libraries (e.g., system libraries 1334, API libraries 1336, and other libraries 1338), and frameworks/middleware 1318 to create user interfaces to interact with users of the system. Alternatively, or additionally, in some systems, interactions with a user may occur through a presentation layer, such as the presentation layer 1344. In these systems, the application/module “logic” can be separated from the aspects of the application/module that interact with a user.

Some software architectures utilize virtual machines. In the example of FIG. 13, this is illustrated by a virtual machine 1348. A virtual machine creates a software environment where applications/modules can execute as if they were executing on a hardware machine (e.g., the machine 1400 of FIG. 14). A virtual machine 1348 is hosted by a host operating system (e.g., operating system 1314) and typically, although not always, has a virtual machine monitor 1346, which manages the operation of the virtual machine 1348 as well as the interface with the host operating system (e.g., operating system 1314). A software architecture executes within the virtual machine 1348 such as an operating system 1350, libraries 1352, frameworks 1354, applications 1356, or presentation layer 1358. These layers of software architecture executing within the virtual machine 1348 can be the same as corresponding layers previously described or may be different.

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1416 (e.g., software, a program, an application, an applet, an app, or other executable code) for causing the machine 1400 to perform any one or more of the methodologies discussed herein may be executed. For example, the instructions 1416 may cause the machine 1400 to execute any one of the respective methods 1000, 1100, and 1200 of FIGS. 10, 11, and 12. Additionally, or alternatively, the instructions 1416 may implement any combination of one or more of the components of FIG. 2, and so forth.

The instructions 1416 transform the machine 1400 into a particular machine programmed to carry out the described and illustrated functions in the manner described. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1416, sequentially or otherwise, that specify actions to be taken by machine 1400. Further, while only a single machine 1400 is illustrated, the term “machine” shall also be taken to include a collection of machines 1400 that individually or jointly execute the instructions 1416 to perform any one or more of the methodologies discussed herein.

The machine 1400 may include processors 1410, memory 1430, and. I/O components 1450, which may be configured to communicate with each other such as via a bus 1402. In an example embodiment, the processors 1410 (e.g., a Central Processing Unit (CPU), a Reduced instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1412 and processor 1414 that may execute instructions 1416. The term “processor” is intended to include multi-core processor that may comprise two or more independent processors (sometimes referred to as “cores”) that may execute instructions contemporaneously. Although FIG. 14 shows multiple processors 1410, the machine 1400 may include a single processor with a single core, a single processor with multiple cores (e.g., a multi-core process), multiple processors with a single core, multiple processors with multiples cores, or any combination thereof.

The memory/storage 1430 may include a memory 1432, such as a main memory, or other memory storage, and a storage unit 1436, both accessible to the processors 1410 such as via the bus 1402. The storage unit 1436 and memory 1432 store the instructions 1416 embodying any one or more of the methodologies or functions described herein. The instructions 1416 may also reside, completely or partially, within the memory 1432, within the storage unit 1436, within at least one of the processors 1410 (e.g., within the processor's cache memory), or any suitable combination thereof, during execution thereof by the machine 1400. Accordingly, the memory 1432, the storage unit 1436, and the memory of processors 1410 are examples of machine-readable media.

As used herein, “machine-readable medium” means a device able to store or carry instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1416. The term “machine-readable medium” shall also be taken to include any medium, or combination of multiple media, that is capable of storing or carrying instructions (e.g., instructions 1416) for execution by a machine (e.g., machine 1400), such that the instructions, when executed by one or more processors of the machine 1400 (e.g., processors 1410), cause the machine 1400 to perform any one or more of the methodologies described herein. Accordingly, a “machine-readable storage medium” refers to a single storage apparatus or device, as well as “cloud-based” storage systems or storage networks that include multiple storage apparatus or devices. The term “machine-readable medium” includes transmission media such as signals.

The I/O components 1450 may include a wide variety of components to receive input, provide output, produce output, transmit information, exchange information, capture measurements, and so on. The specific I/O components 1450 that are included in a particular machine will depend on the type of machine. For example, portable machines such as mobile phones will likely include a touch input device or other such input mechanisms, while a headless server machine will likely not include such a touch input device. It will be appreciated that the I/O components 1450 may include many other components that are not shown in FIG. 14. The I/O components 1450 are grouped according to functionality merely for simplifying the following discussion and the grouping is in no way limiting. In various example embodiments, the I/O components 1450 may include output components 1452 and input components 1454. The output components 1452 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1454 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1450 may include biometric components 1456, motion components 1458, environmental components 1460, or position components 1462 among a wide array of other components. For example, the biometric components 1456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1458 may include acceleration sensor components (e.g., accelerometer), gravitation sensor components, rotation sensor components (e.g., gyroscope), and so forth. The environmental components 1460 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1462 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1450 may include communication components 1464 operable to couple the machine 1400 to a network 1480 or devices 1470 via coupling 1482 and coupling 1472 respectively. For example, the communication components 1464 may include a network interface component or other suitable device to interface with the network 1480. In further examples, communication components 1464 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1470 may be another machine or any of a wide variety of peripheral devices (e.g., a peripheral device coupled via a Universal Serial Bus (USB)).

Moreover, the communication components 1464 may detect identifiers or include components operable to detect identifiers. For example, the communication components 1464 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1464, such as, location via Internet Protocol (IP) geo-location, location via Wi-Fi® signal triangulation, location via detecting a NFC beacon signal that may indicate a particular location, and so forth.

In various example embodiments, one or more portions of the network 1480 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone network (PSTN), a plain old telephone service (POTS) network, a cellular telephone network, a wireless network, a Wi-Fi® network, another type of network, or a combination of two or more such networks. For example, the network 1480 or a portion of the network 1480 may include a wireless or cellular network and the coupling 1482 may be a Code Division Multiple Access (CDMA) connection, a Global System for Mobile communications (GSM) connection, or other type of cellular or wireless coupling. In this example, the coupling 1482 may implement any of a variety of types of data transfer technology, such as Single Carrier Radio Transmission Technology (1×RTT, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1416 may be transmitted or received over the network 1480 using a transmission medium via a network interface device (e.g., a network interface component included in the communication components 1464) and utilizing any one of a number of well-known transfer protocols (e.g., hypertext transfer protocol (HTTP)). Similarly, the instructions 1416 may be transmitted or received using a transmission medium via the coupling 1472 (e.g., a peer-to-peer coupling) to devices 1470. The term “transmission medium” shall be taken to include any computer-readable medium that is capable of encoding or carrying instructions 1416 for execution by the machine 1400, and includes digital or analog communications signals or other intangible medium to facilitate communication of such software.

The following numbered examples are embodiments.

1. A computer-implemented method comprising:
determining, by one or more hardware processors, an identification of a target product;
identifying, by the one or more hardware processors, online transactions for the target product based on the identification of the target product, the online transactions involving purchasers of the target product;
identifying, by the one or more hardware processors, corresponding product models for the purchasers of the target product;
selecting, by the one or more hardware processors, at least one compatible model for the target product from the identified product models; and
causing, by the one or more hardware processors, a recommendation for the at least one compatible model to be displayed on a computing device, the recommendation recommending that the at least one compatible model for the target product be included in a title of an item listing for the target product.

2. The computer-implemented method of example 1, wherein the online transactions for the target product are identified based on the online transactions occurring during a most recent period of time.

3. The computer-implemented method of example 1 or example 2, wherein the selecting the at least one compatible model for the target product from the identified product models comprises:
ranking the identified product models based on a corresponding number of online transactions for each one of the identified product models; and
selecting the at least one compatible model for target product based on the ranking.

4. The computer-implemented method of any one of examples 1 to 3, wherein the recommendation is displayed within a listing creation user interface operable to receive user input for creating the item listing.

5. The computer-implemented method of any one of examples 1 to 4, wherein the identification of the target product is determined based on at least one of a keyword and an image submitted as input via a listing creation user interface operable to receive user input for creating the item listing.

6. The computer-implemented method of any one of examples 1 to 5, wherein the recommendation for the at least one compatible model is displayed as an auto-completion suggestion for a user interface element of a listing creation user interface operable to receive user input for creating the item listing, the recommendation being displayed based on one or more keywords submitted as input via the listing creation user interface.

7. The computer-implemented method of any one of examples 1 to 6, further comprising:
receiving, by the one or more hardware processors, keywords submitted by a user to be included in the title of the item listing for the target product via a listing creation user interface operable to receive user input for creating the item listing; and
determining, by the one or more hardware processors, that the keywords submitted by the user comprise a total number of compatible models that exceeds a maximum threshold number of compatible models for the title of the item listing,
wherein the recommendation for the at least one compatible model is caused to be displayed on the computing device based on the determination that the keywords submitted by the user comprise the total number of compatible models that exceeds the maximum threshold number of compatible models.

8. The computer-implemented method of any one of examples 1 to 7, further comprising determining that one or more of the keywords are not included in the selected at least one compatible model, wherein the recommendation comprises a suggestion to remove the one or more of the keywords based on the determination that the one or more of the keywords are not included in the selected at least one compatible model.

9. The computer-implemented method of any one of examples 1 to 8, further comprising storing, by the one or more hardware processors, the at least one compatible model in a database in association with the target product, wherein the causing the recommendation for the at least one compatible model to be displayed on the computing device comprises:
detecting that a user is creating the item listing for the target product via a listing creation user interface operable to receive user input for creating the item listing; and
retrieving the at least one compatible model from the database for inclusion in the recommendation based on the detecting that the user is creating the item listing for the target product.

10. A system comprising:
at least one processor; and
a non-transitory computer-readable medium storing executable instructions that, when executed, cause the at least one processor to perform the method of any one of examples 1 to 9.

11. A non-transitory machine-readable storage medium, tangibly embodying a set of instructions that, when executed by at least one processor, causes the at least one processor to perform the method of any one of examples 1 to 9.

12. A machine-readable medium carrying a set of instructions that, when executed by at least one processor, causes the at least one processor to carry out the method of any one of examples 1 to 9.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure, in general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof show; by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
determining, by one or more hardware processors, an identification of a target product;
identifying, by the one or more hardware processors, online transactions for the target product based on the identification of the target product, the online transactions involving purchasers of the target product;
identifying, by the one or more hardware processors, corresponding product models for the purchasers of the target product;
selecting, by the one or more hardware processors, at least one compatible model for the target product from the identified product models; and
causing, by the one or more hardware processors, a recommendation for the at least one compatible model to be displayed on a computing device, the recommendation recommending that the at least one compatible model for the target product be included in a title of an item listing for the target product.

2. The computer-implemented method of claim 1, wherein the online transactions for the target product are identified based on the online transactions occurring during a most recent period of time.

3. The computer-implemented method of claim 1, wherein the selecting the at least one compatible model for the target product from the identified product models comprises:
ranking the identified product models based on a corresponding number of online transactions for each one of the identified product models; and
selecting the at least one compatible model for target product based on the ranking.

4. The computer-implemented method of claim 1, wherein the recommendation is displayed within a listing creation user interface operable to receive user input for creating the item listing.

5. The computer-implemented method of claim 1, wherein the identification of the target product is determined based on at least one of a keyword and an image submitted as input via a listing creation user interface operable to receive user input for creating the item listing.

6. The computer-implemented method of claim 1, wherein the recommendation for the at least one compatible model is displayed as an auto-completion suggestion for a user interface element of a listing creation user interface operable to receive user input for creating the item listing, the recommendation being displayed based on one or more keywords submitted as input via the listing creation user interface.

7. The computer-implemented method of claim 1, further comprising:
receiving, by the one or more hardware processors, keywords submitted by a user to be included in the title of the item listing for the target product via a listing creation user interface operable to receive user input for creating the item listing; and
determining, by the one or more hardware processors, that the keywords submitted by the user comprise a total number of compatible models that exceeds a maximum threshold number of compatible models for the title of the item listing,
wherein the recommendation for the at least one compatible model is caused to be displayed on the computing device based on the determination that the keywords submitted by the user comprise the total number of compatible models that exceeds the maximum threshold number of compatible models.

8. The computer-implemented method of claim 7, further comprising determining that one or more of the keywords are not included in the selected at least one compatible model, wherein the recommendation comprises a suggestion to remove the one or more of the keywords based on the determination that the one or more of the keywords are not included in the selected at least one compatible model.

9. The computer-implemented method of claim 1, further comprising storing, by the one or more hardware processors, the at least one compatible model in a database in association with the target product, wherein the causing the recommendation for the at least one compatible model to be displayed on the computing device comprises:
detecting that a user is creating the item listing for the target product via a listing creation user interface operable to receive user input for creating the item listing; and
retrieving the at least one compatible model from the database for inclusion in the recommendation based on the detecting that the user is creating the item listing for the target product.

10. A system comprising:
at least one hardware processor; and
a computer-readable storage medium storing executable instructions that, when executed, cause the at least one hardware processor to perform operations comprising:
determining an identification of a target product;
identifying online transactions for the target product based on the identification of the target product, the online transactions involving purchasers of the target product;
identifying corresponding product models for the purchasers of the target product;
selecting at least one compatible model for the target product from the identified product models; and
causing a recommendation for the at least one compatible model to be displayed on a computing device, the recommendation recommending that the at least one compatible model for the target product be included in a title of an item listing for the target product.

11. The system of claim 10, wherein the online transactions for the target product are identified based on the online transactions occurring during a most recent period of time.

12. The system of claim 10, wherein the selecting the at least one compatible model for the target product from the identified product models comprises:
ranking the identified product models based on a corresponding number of online transactions for each one of the identified product models; and
selecting the at least one compatible model for target product based on the ranking.

13. The system of claim 10, wherein the recommendation is displayed within a listing creation user interface operable to receive user input for creating the item listing.

14. The system of claim 10, wherein the identification of the target product is determined based on at least one of a keyword and an image submitted as input via a listing creation user interface operable to receive user input for creating the item listing.

15. The system of claim 10, wherein the recommendation for the at least one compatible model is displayed as an auto-completion suggestion for a user interface element of a listing creation user interface operable to receive user input for creating the item listing, the recommendation being displayed based on one or more keywords submitted as input via the listing creation user interface.

16. The system of claim 10, wherein the operations further comprise:
receiving keywords submitted by a user to be included in the title of the item listing for the target product via a listing creation user interface operable to receive user input for creating the item listing; and
determining that the keywords submitted by the user comprise a total number of compatible models that exceeds a maximum threshold number of compatible models for the title of the item listing,
wherein the recommendation for the at least one compatible model is caused to be displayed on the computing device based on the determination that the keywords submitted by the user comprise the total number of compatible models that exceeds the maximum threshold number of compatible models.

17. The system of claim 16, wherein the operations further comprise determining that one or more of the keywords are not included in the selected at least one compatible model, wherein the recommendation comprises a suggestion to remove the one or more of the keywords based on the determination that the one or more of the keywords are not included in the selected at least one compatible model.

18. The system of claim 10, wherein the operations further comprise storing the at least one compatible model in a database in association with the target product, wherein the causing the recommendation for the at least one compatible model to be displayed on the computing device comprises:
detecting that a user is creating the item listing for the target product via a listing creation user interface operable to receive user input for creating the item listing; and
retrieving the at least one compatible model from the database for inclusion in the recommendation based on the detecting that the user is creating the item listing for the target product.

19. A non-transitory machine-readable storage medium storing a set of instructions that, when executed by at least one processor, causes the at least one processor to perform operations comprising:
determining an identification of a target product;
identifying online transactions for the target product based on the identification of the target product, the online transactions involving purchasers of the target product;
identifying corresponding product models for the purchasers of the target product;
selecting at least one compatible model for the target product from the identified product models; and
causing a recommendation for the at least one compatible model to be displayed on a computing device, the recommendation recommending that the at least one compatible model for the target product be included in a title of an item listing for the target product.

20. The non-transitory machine-readable storage medium of claim 19, wherein the online transactions for the target product are identified based on the online transactions occurring during a most recent period of time.
